(19) United States
(12) Patent Application Publication
(10) Pub. No.: US 2013/0160902 A1
(43) Pub. Date: Jun. 27, 2013

(54) MANUFACTURING METHOD FOR COMPOSITE ALLOY BONDING WIRE

(71) Applicant: Jun-Der LEE, Lu-Chu Hsiang (TW)

(72) Inventor: Jun-Der LEE, Lu-Chu Hsiang (TW)

(21) Appl. No.: 13/607,116

(22) Filed: Sep. 7, 2012

Related U.S. Application Data
(63) Continuation-in-part of application No. 13/334,047, filed on Dec. 21, 2011, now abandoned.

(51) Int. Cl. B23K 35/40

(52) U.S. Cl. 148/557

(57) ABSTRACT

A manufacturing method for a composite alloy bonding wire and products thereof are provided. A primary material of Ag is melted in a vacuum melting furnace, and then a secondary metal material of Pd is added into the vacuum melting furnace and is co-melted with the primary material to obtain an Ag—Pd alloy solution. The obtained Ag—Pd alloy solution is drawn to obtain an Ag—Pd alloy wire. The Ag—Pd alloy wire is then drawn to obtain an Ag—Pd alloy bonding wire with a predetermined diameter.

### RELATED APPLICATIONS

This application is divisional application of U.S. patent application Ser. No. 13/334,047, filed on Dec. 21, 2011.

### BACKGROUND OF THE INVENTION

1. Field of the Invention

The present invention generally relates to a manufacturing method for a bonding wire used as a packaging wire, in particular, to a manufacturing method for a bonding wire used in the semiconductor packaging process.

2. Description of Related Art

In semiconductor device packaging processes for IC, LED, SAW, a wire bonding process is often performed to electrically connect the chip to the substrate by a bonding wire which is used as a signal and electrical current transmitting medium between the chip and the substrate.

The primary characteristics of the bonding wire, such as the breaking load, elongation, loop, melting point, and bondability with IC chips depend on the materials of the bonding wire. The performance of the packaged semiconductor device is influenced by the characteristics of the bonding wire. According to different types of chip and substrate, the adapted bonding wire has different specification.

The conventional bonding wires are usually made of pure Au material. Pure Au bonding wire has better physical properties, such as elongation and electrical conductivity. However, pure Au bonding wire inevitably leads to a high cost.

Therefore, the subject of the present invention is to solve the above mentioned problem to provide a low cost bonding wire with performance comparable to pure Au bonding wire.

German patent no. DE 3122996 “Silver-palladium-magnesium-aluminum alloy for internally oxidized electrical contacts, e.g. spring contacts” is related to an alloy used for electrical breaker and sliding contacts, e.g. in relays, switches and potentiometers. The alloy has the composition (by wt.) of 5-30% Pd, 0.1-0.5% Mg, 0.01-0.5% Al and balance Ag, which is not suitable for making as a bonding wire used for IC, LED, SAW because of following reasons.

1. When wt. % of Pd is more than 10%, the hardness of the wire will be larger than 150-200 kp/mm2. In comparison, the hardness of the bonding wire is normal 60-90 kp/mm2. That is, the wire made by the alloy of DE 3122996 may not be drawn to have a diameter as or less than 0.0175 mm (0.7 mil), and a soldering process may not be performed because it may cause cracking or catering to the IC or LED due to the hardness of the wire.

2. Adding Mg will increase the wear resistance and hardness of the alloy. After adding Mg, an oxidation process may have to be performed to obtain MgO particles in the alloy. However, MgO will make the alloy become hard and brittle to be used as a bonding wire for IC and LED. Besides, MgO will increase the resistance of the alloy and decrease the conductivity of the alloy. That is also not good for the alloy to be as a bonding wire.

3. Adding Al will decrease the elongation of the alloy and increase the resistance of the alloy. In addition, adding Al in Ag will produce various configurations of Ag and Al compound in the alloy. These are negative for the alloy to be as the bonding wire.

4. The resistance of the alloy of DE 3122996 is about 0.08-0.16 ohm, mm2/m which is 160-170 times of 0.00023-0.00050 ohm, mm2/m for a general resistance of a bonding wire. The higher the resistance of the bonding wire is, the lower the conductivity will be. The bonding wire with high resistance will reduce the transmission speed and the lifespan of the IC or LED. In addition, Ag-based alloy wire such as Ag—Pd alloy wire for a semiconductor package has disclosed in related art for example Japanese patent application publication no. JP9275120 and US patent application publication nos. US 2008/240975 and US 2008/230915. However, as manufacturing process of Ag—Pd alloy wire is different, the structure of Ag—Pd alloy wire may be different. The Ag—Pd alloy wire with different structure would have different properties such as tensile strength, toughness, elongation, hardness, electrical conductivity, thermal conductivity, anti-oxidation, corrosion resistance and higher electro-migration resistance.

Annealing, in metallurgy and materials science, is a heat treatment wherein a material is altered, causing changes in its properties such as hardness and elongation. It is a process that produces conditions by heating to above the critical temperature, maintaining a suitable temperature, and then cooling. Annealing is used to induce elongation, soften material, relieve internal stresses, refine the structure by making it homogeneous, and improve cold working properties. Therefore, annealing process is important for ensuring a final product with desirable physical properties.

### SUMMARY OF THE INVENTION

The present invention is to provide a low cost composite alloy bonding wire made of silver and Palladium, capable of having performance as good as a pure Au bonding wire.

Accordingly, a manufacturing method for a composite alloy bonding wire is disclosed. A primary metal material of Ag is melted in a vacuum melting furnace, and then a secondary metal material of Pd is added into the vacuum melting furnace and is co-melted with the primary metal material of Ag to obtain an Ag—Pd alloy solution. The obtained Ag—Pd alloy solution is then cast and drawn to obtain an Ag—Pd alloy wire. Finally, the obtained Ag—Pd alloy wire is then drawn to obtain an Ag—Pd alloy bonding wire with a predetermined diameter. An amount of cold working in the final drawing is between 2% and 10%.

Besides, a composite alloy bonding wire made by the abovementioned manufacturing method is provided. The composite alloy bonding wire includes 90.00˜99.99 wt. % Ag and 0.01˜10.00 wt. % but no more than 10.00 wt. % Pd, besides unavoidable impurities. The composite alloy bonding wire has slender grains and annealing twins and the amount of the annealing twins to all grains is above 20%.

The composite alloy bonding wire made of silver and palladium has performance as good as a pure Au bonding wire and a lower manufacturing cost.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a flow chart for manufacturing composite alloy bonding wire of the present invention; and

FIG. 2 shows detailed sub-steps in the flow chart of FIG. 1.

FIG. 3 schematically shows a longitudinal sectional view of slender grains and annealing twins in the structure of composite alloy bonding wire of the present invention.

FIG. 4 shows a photograph of slender grains and annealing twins in the structure of composite alloy bonding wire of the present invention.

FIG. 5 shows a photograph of the structure of composite alloy bonding wire made by a conventional method.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

Pure Ag has good characteristics as compared to Au or Cu (See below Table 1). However, Ag could not be used as a bonding wire as Au or Cu because during the process of ball bonding, an interfacial reaction will occur between Ag and Al which is in the Al pad formed on a chip to produce the intermetallic compounds such as Ag₂Al and AgAl₄ which have the hard and brittle characteristics. Meanwhile, the difference between the diffusion rates of Ag and Al is so significant, kirkendall voids will be created. As a result, high electrical resistance or open circuits, weak bond adherence or brittle bond heels will be created. The whole integrated circuit should lose its function.

TABLE 1

| Item | | Unit | Gold | Silver | Copper | Palladium |
|---|---|---|---|---|---|---|
| Atomic Symbol | | — | Au | Ag | Cu | Pd |
| Atomic Number | | — | 79 | 47 | 29 | 46 |
| Melting Point | | ° C. | 1064.4 | 961.9 | 1083 | 1554 |
| Boiling Point | | ° C. | 3080 | 2212 | 2567 | 3140 |
| Density, 20° C. | | g/cm³ | 19.3 | 10.5 | 8.96 | 12.0 |
| Resistivity, 20° C. | | μΩcm | 2.3 | 1.63 | 1.69 | 10.8 |
| Thermal Conductivity | | W/mK | 316 | 429 | 401 | 71.8 |
| Specific Heat | | J/Kg K | 130 | 234 | 386 | 244 |
| Hardness | Mohs | — | 2.5 | 2.5 | 3.0 | 4.75 |
| | Hardness | | | | | |
| | Vickers | MN/m² | 215 | 215 | 369 | 461 |
| | Hardness | | | | | |

Nevertheless, Ag should be used as a base metal because of its density, hardness, electrical conductivity, thermal conductivity and the cost. The density of Ag is 10.5 g/cm3, while in is 54.4% of Au. It is light enough to meet the weight requirement of the electronic products. In addition, comparing the hardness of Ag, Au, Cu and Pd, the order is Pd, Cu, Ag and Au from high hardness to low hardness. Under either Mohs or Vickers hardness examination, the harness of Ag is the closest to that of Au. The hardness is critical to IC, LED and SAW because if the material of packaging wire is too hard, it is easy to break or go through the IC chips and destroy the IC, LED or SAW package.

Comparing the electrical resistance of Ag, Au, Cu and Pd, the order is Pd, Au, Cu, Ag from high resistance to low resistance. Ag has the lowest resistance and has the best conductivity. Therefore, the alloy using Ag as a base metal is a good conductor, which is important to IC, LED and SAW.

Comparing the thermal conductivity of Ag, Au, Cu and Pd, the order is Ag, Cu, Au and Pd from high to low. Thermal conductivity of Ag is the biggest and it means Ag has the best cooling capacity, which is important to IC, LED and SAW.

Ag with the purity higher than 99.99% is easy to be broken because its hardness is low during the wire drawing process. As a result, during wire bonding process, partial wire arc may collapse because of the soft material, which may cause short circuit between the wire and cause IC, LED and SAW unable to use.

If pure Pd is used to be the base of the packaging wire, it is not practical because of the hardness, electrical resistance and high cost. Therefore, when Ag is used as the basic material for the alloy, other elements must be added to change the property of Ag. In the present application, the alloy includes Pd and excludes Mg and Al. The advantages of adding Pd are (1) to increase the oxidation resistant effect; (2) to increase the oxidation resistance; (3) to decrease the diffusion rate between Ag and Al, thus to avoid the cracking of the intermetallic compounds and the creation of kirkendall voiding.

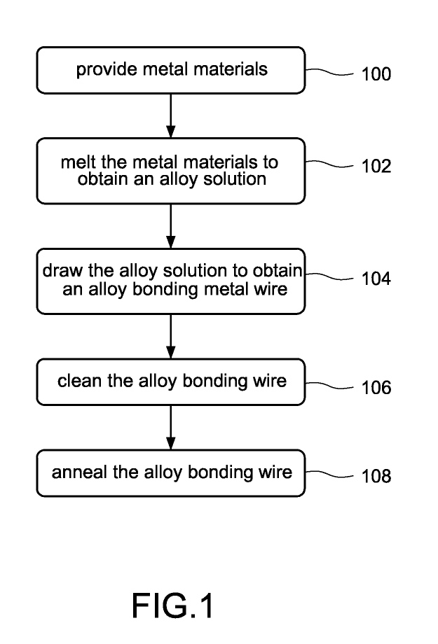

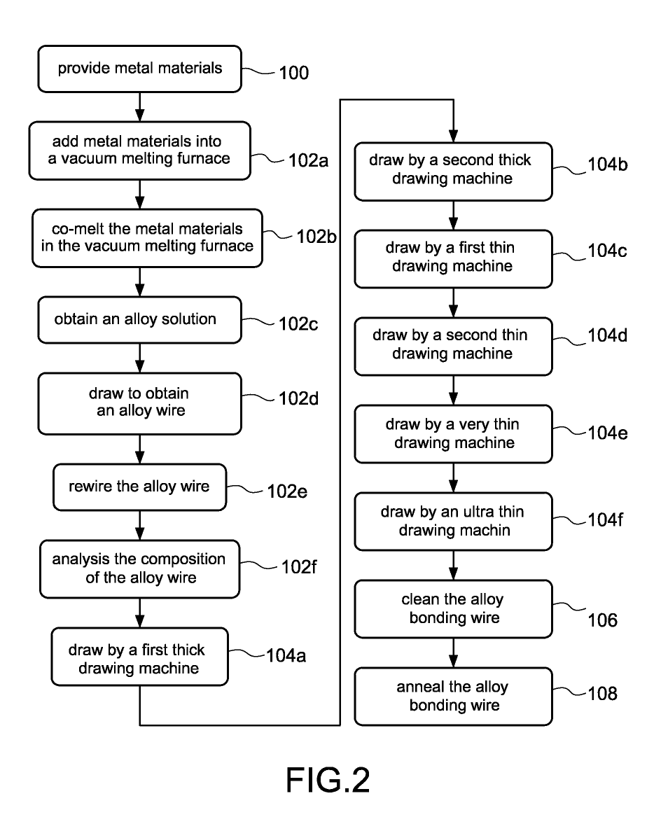

Refer to FIG. 1 and FIG. 2, which respectively are a flow chart for manufacturing composite alloy bonding wire of the present invention and a drawing showing detailed sub-steps in the flow chart of FIG. 1.

Step 100, a primary material of Ag is provided.

Step 102, the primary material is melted in a vacuum melting furnace (step 102a). Specific amount of a secondary metal material of Pd is added into the vacuum melting furnace (step 102b), and co-melted with the primary material in the vacuum melting furnace to obtain an Ag—Pd alloy solution (step 102c). The Ag—Pd alloy solution consists of 90.00˜99.99 wt. % Ag and 0.01˜10.00 wt. % but no more than 10.00 wt. % Pd, besides unavoidable impurities.

Subsequently, continuous casting and drawing processes are performed on the Ag—Pd alloy solution to obtain an Ag—Pd alloy wire with diameter of 4-8 mm (step 102d). The Ag—Pd alloy wire is rewired by a reeling machine (step 102e) and then composition analysis (102f) is performed on the Ag—Pd alloy wire to check if the obtained composition meets the requirement.

Step 104, a drawing process is performed on the Ag—Pd alloy wire; the obtained Ag—Pd alloy wire with a diameter of 4-8 mm is drawn by a first thick drawing machine to obtain an Ag—Pd alloy wire with a diameter of 3 mm or smaller than 3 mm (step 104a). The Ag—Pd alloy wire with a diameter of 3 mm or smaller than 3 mm is drawn by a second thick drawing machine to obtain an Ag—Pd alloy wire with a predetermined diameter of 1 mm or smaller than 1 mm (step 104b). The Ag—Pd alloy wire with diameter 1 mm or smaller than 1 mm is drawn by a first thin drawing machine to obtain an Ag—Pd alloy wire with a diameter of 0.5 mm or smaller than 0.5 mm (step 104c). Then the Ag—Pd alloy wire with a diameter of 0.5 mm or smaller than 0.5 mm is sequentially drawn by the second thin drawing machine (step 104d), a very thin drawing machine (step 104e) and an ultra thin drawing machine (step 104f) to obtain an ultra thin Ag—d alloy bonding wire with a predetermined diameter of 0.0508 mm (2.00 mil) to 0.010 mm (0.40 mil). An amount of cold working in step 104f is between 2% and 10%.

Step 106, the surface of the Ag—Pd alloy bonding wire is cleaned.

Step 108, the Ag—Pd alloy bonding wire is annealed to ensure a final product with desirable physical properties of breaking load and elongation. The Ag—Pd alloy bonding wire is annealed from 1200° C. to 25° C. for 0.3 to 5 seconds.

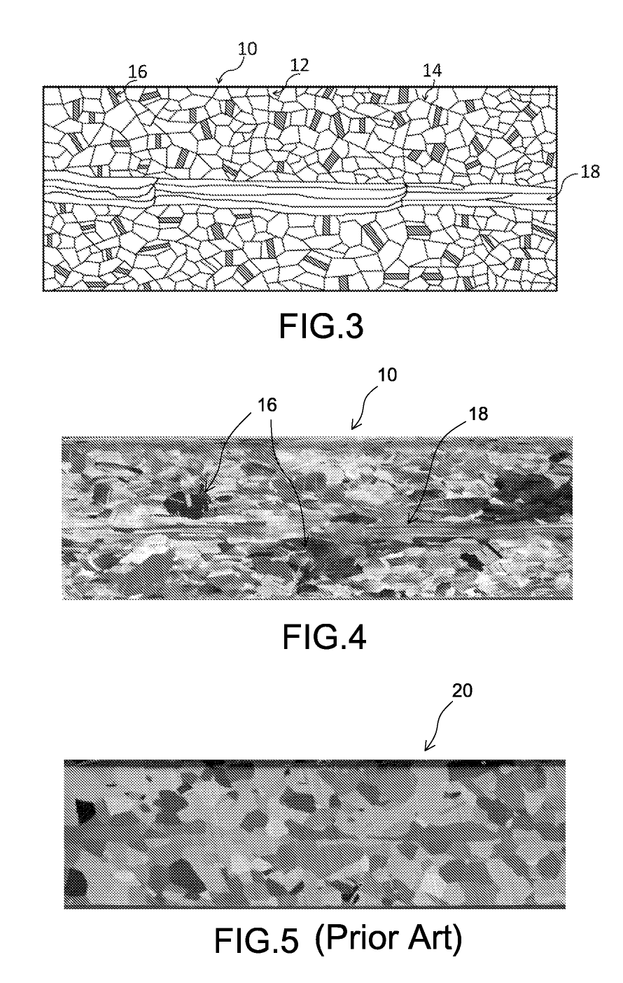

FIG. 3 schematically shows a longitudinal sectional view of slender grains and annealing twins in the structure of composite alloy bonding wire of the present invention. As shown in FIG. 3, the slender grains 18 are adjacent to a central site of the composite alloy bonding wire 10. Reference numerals 12, 14 and 16 respectively represent coaxial grains, high angle crystal boundary and annealing twins.

FIG. 4 shows a photograph of slender grains and annealing twins in the structure of composite alloy bonding wire of the present invention. FIG. 5 shows a photograph of the structure of composite alloy bonding wire made by a conventional method. Referring to FIG. 4, in case of the present invention, composite alloy bonding wire 10 has slender grains 18 and annealing twins 16 and the amount of the annealing twins 16 to all grains is above 20%. Referring to FIG. 5, in case of the conventional method, composite alloy bonding wire 20 has none of slender grains and annealing twins.

The Ag—Pd alloy bonding wire can be applied to packaging process of IC, LED and SAW because the hardness of the bonding wire is within the range of 60-90 kp/mm2, and the resistance of the bonding wire is within the range of 0.00023-0.00050 ohm, mm2/m.

The invention is more detailed described by three embodiments below:

### Embodiment 1

A primary material of Ag is provided and is melted in a vacuum melting furnace. Then, specific amount of a secondary metal material of Pd is added into the vacuum melting furnace, and is co-melted with the primary material in the vacuum melting furnace to obtain an Ag—Pd alloy solution. The Ag—Pd alloy solution consists of: 99.99 wt. % Ag and 0.001 wt. % Pd, besides unavoidable impurities. The composite alloy bonding wire has slender grains and annealing twins and the amount of the annealing twins to all grains is above 20%.

Continuous casting and drawing processes are performed on the Ag—Pd alloy solution to obtain an Ag—Pd alloy wire with a diameter of 4 mm. The Ag—Pd alloy wire is rewired by a reeling machine and then composition analysis is performed on the Ag—Pd alloy wire to check if the obtained composition meets the requirement.

A drawing process is performed on the Ag—Pd alloy wire; the obtained Ag—Pd alloy wire with a diameter of 4 mm is drawn by a first thick drawing machine to obtain an Ag—Pd alloy wire with a diameter of 3 mm. The Ag—Pd alloy wire with a diameter of 3 mm is drawn by a second thick drawing machine to obtain an Ag—Pd alloy wire with a diameter of 1 mm. The Ag—Pd alloy wire with a diameter of 1 mm is drawn by a first thin drawing machine to obtain an Ag—Pd alloy wire with a diameter of 0.18 mm. Then the Ag—Pd alloy wire with a diameter of 0.18 mm is sequentially drawn by the second thin drawing machine, a very thin drawing machine and an ultra thin drawing machine to obtain an ultra thin Ag—Pd alloy bonding wire with a predetermined diameter of 0.050 mm to 0.010 mm. An amount of cold working in the final drawing is between 2% and 10%.

Finally, the surface of Ag—Pd alloy bonding wire is cleaned and is annealed. The Ag—Pd alloy bonding wire is annealed from 1200° C. to 25° C. for 0.3 to 5 seconds. Under the above conditions, most of the grains inside contain annealing twin boundary with low energies that is stable than the conventional high angle grain boundary of grains in a wire.

### Embodiment 2

A primary material of Ag is provided and is melted in a vacuum melting furnace. Then, specific amount of a secondary metal material of Pd is added into the vacuum melting furnace, and is co-melted with the primary material in the vacuum melting furnace to obtain an Ag—Pd alloy solution. The Ag—Pd alloy solution consists of: 95.00 wt. % Ag and 5.00 wt. % Pd, besides unavoidable impurities. The composite alloy bonding wire has slender grains and annealing twins and the amount of the annealing twins to all grains is above 20%.

Continuous casting and drawing processes are performed on the Ag—Pd alloy solution to obtain an Ag—Pd alloy wire with a diameter of 6 mm. The Ag—Pd alloy wire is rewired by a reeling machine and then composition analysis is performed on the Ag—Pd alloy wire to check if the obtained composition meets the requirement.

A drawing process is performed on the Ag—Pd alloy wire; the obtained Ag—Pd alloy wire with a diameter of 6 mm is drawn by a first thick drawing machine to obtain an Ag—Pd alloy wire with a diameter of 3 mm. The Ag—Pd alloy wire with a diameter of 3 mm is drawn by a second thick drawing machine to obtain an Ag—Pd alloy wire with a diameter of 1.0 mm. The Ag—Pd alloy wire with a diameter of 1.0 mm is drawn by a first thin drawing machine to obtain an Ag—Pd alloy wire with a diameter of 0.18 mm. Then the Ag—Pd alloy wire with a diameter of 0.18 mm is sequentially drawn by the second thin drawing machine, a very thin drawing machine and an ultra thin drawing machine to obtain an ultra thin Ag—Pd alloy bonding wire with a predetermined diameter of 0.050 mm to 0.010 mm. An amount of cold working in the final drawing is between 2% and 10%.

Finally, the surface of Ag—Pd alloy bonding wire is cleaned and is annealed. The Ag—Pd alloy bonding wire is annealed from 1200° C. to 25° C. for 0.3 to 5 seconds.

### Embodiment 3

A primary material of Ag is provided and is melted in a vacuum melting furnace. Then, specific amount of a secondary metal material of Pd is added into the vacuum melting furnace, and is co-melted with the primary material in the vacuum melting furnace to obtain an Ag—Pd alloy solution. The Ag—Pd alloy solution consists of: 90.00 wt. % Ag and 10.00 wt. % Pd, besides unavoidable impurities. The composite alloy bonding wire has slender grains and annealing twins and the amount of the annealing twins to all grains is above 20%.

Continuous casting and drawing processes are performed on the Ag—Pd solution to obtain an Ag—Pd alloy wire with a diameter of 8 mm. The Ag—Pd alloy wire is rewired by a reeling machine and then composition analysis is performed on the Ag—Pd alloy wire to check if the obtained composition meets the requirement.

A drawing process is performed on the Ag—Pd alloy wire; the obtained Ag—Pd alloy wire with a diameter of 8 mm is drawn by a first thick drawing machine to obtain an Ag—Pd alloy wire with a diameter of 2 mm. The Ag—Pd alloy wire with a diameter of 2 mm is drawn by a second thick drawing machine to obtain an Ag—Pd alloy wire with a diameter of 1.0 mm. The Ag—Pd alloy wire with a diameter of 1.0 mm is drawn by a first thin drawing machine to obtain an Ag—Pd alloy wire with a diameter of 0.18 mm. Then the Ag—Pd alloy wire with a diameter of 0.18 mm is sequentially drawn by the second thin drawing machine, a very thin drawing machine and an ultra thin drawing machine to obtain an ultra thin Ag—Pd alloy bonding wire with a predetermined diameter of 0.050 mm to 0.010 mm. An amount of cold working in the final drawing is between 2% and 10%.

Finally, the surface of Ag—Pd alloy bonding wire is cleaned and is annealed. The Ag—Pd alloy bonding wire is annealed from 1200° C. to 25° C. for 0.3 to 5 seconds.

More examples showing the characteristics for the Ag—Pd alloy bonding wire with the diameter of 1.0 mil of the present are listed as below Table 2.

TABLE 2

| | TYPE | | | | | | |
|---|---|---|---|---|---|---|---|
| | 1 | 2 | 3 | 4 | 5 | 6 | 7 |
| Ag (Wt %) | 99.45% | 98.98 | 97.95 | 96.99 | 95.36 | 93.45 | 91.27 |
| Pd (Wt %) | 0.55 | 1.02 | 2.05 | 3.01 | 4.64 | 6.55 | 8.73 |
| 1.0-0.18 mm | V | V | V | V | V | V | V |
| 0.18-0.05 mm | V | V | V | V | V | V | V |
| 0.05-0.038 mm | V | V | V | V | V | V | V |
| 0.038-0.03 mm | V | V | V | V | V | V | V |
| 0.03-0.025 mm | V | V | V | V | V | V | V |
| Drawing Test | V | V | V | V | V | V | V |
| Break Load | 11.21 | 12.65 | 13.11 | 13.43 | 13.65 | 14.37 | 16.27 |
| (gf) | | | | | | | |
| Elongation | 2.41 | 2.65 | 2.12 | 2.57 | 3.89 | 2.83 | 0.61 |
| (%) | | | | | | | |
| Hardness | 56.8 | 57.1 | 57.4 | 57.8 | 58.2 | 64.5 | 71.5 |
| (Hv) | | | | | | | |
| Resistance | 1.72 | 1.76 | 1.84 | 2.14 | 3.50 | 4.62 | 5.66 |
| (μΩcm) | | | | | | | |

Specifically, the Type-6 bondability and reliability test report is attached for reference.

Due to slender grains and annealing twins existing in the Ag—Pd alloy bonding wire according to the present invention, it has higher tensile strength, toughness and elongation, lower hardness, preferred electrical conductivity, thermal conductivity, anti-oxidation and corrosion resistance and higher electro-migration resistance, especially having an advantage that a hot zone is not caused when a wire bonding process is performed.

The properties of the Ag—Pd alloy bonding wire (Ag 96 wt % and Pd 4 wt %) according to the present invention are compared to the Ag—Pd alloy bonding wire (Ag 96 wt % and Pd 4 wt %) made by a conventional method shown as Table 3.

TABLE 3

| | Item | | | |
|---|---|---|---|---|
| | Ag—Pd alloy | | Ag—Pd alloy | |
| | bonding wire | | bonding wire | |
| | according to the | | made by a | |
| | present invention | | conventional method | |
| Grains | slender grains | | none of slender | |
| | and more than | | grains and less | |
| | 20% of annealing | | 10% of annealing | |
| | twins to all grains | | twins to all grains | |
| Breaking Load (gf) | 7-12 | | 4-10 | |
| Elongation (%) | 8-12 | | 2-5 | |
| Elastic Modules (GPa) | 19.2 | | 18.8 | |
| Resistivity (μΩcm) | 3.3 | | >3.7 | |
| Hardness (Hv) | 56-60 | | 65-70 | |
| Electro-migration resistance | 1000 | hrs pass | 700 | hrs fail |
| (input dc 0.3 A) | | | | |
| Temperature cycle test | 1500 | hrs pass | 1000 | hrs fail |
| (TCT) | | | | |
| Highly accelerated stress | 192 | hrs pass | 96 | hrs fail |
| test (HAST) | | | | |

While the invention is described in by way of examples and in terms of preferred embodiments, it is to be understood that the invention is not limited thereto. On the contrary, the aim is to cover all modifications, alternatives and equivalents falling within the spirit and scope of the invention as defined by the appended claims.

1. A manufacturing method for a composite alloy bonding wire, comprising:
a) providing a primary material of Ag;
b) melting the primary material in a vacuum melting furnace, adding a secondary metal material of Pd into the vacuum melting furnace and co-melting with the primary material in the vacuum melting furnace to obtain an Ag—Pd alloy that excludes Mg and Al;
c) casting and drawing the Ag—Pd alloy to obtain an Ag—Pd alloy wire;
d) drawing the Ag—Pd alloy wire to obtain an Ag—Pd alloy bonding wire with a predetermined diameter adapted to be used for packaging processes for IC, LED or SAW; and
e) the surface of the Ag—Pd alloy bonding wire being cleaned and the Ag—Pd alloy bonding wire being annealed from 1200° C. to 25° C. for 0.3 to 5 seconds so that the Ag—Pd alloy bonding wire has slender grains and annealing twins to ensure the Ag—Pd alloy bonding wire with desirable physical properties of breaking load and elongation.

2. The manufacturing method according to claim 1, wherein the weight percent of Ag in step a) is 90.00%˜99.99%.

3. The manufacturing method according to claim 2, wherein the weight percent of Pd in step b) is not more than 10.00 wt. %.

4. The manufacturing method according to claim 1, wherein an amount of cold working in step d) is between 2% and 10%.

5. The manufacturing method according to claim 1, wherein the Ag—Pd alloy bonding wire can be applied to the packaging process of IC, LED and SAW because a hardness of the Ag—Pd alloy bonding wire is within the range of 60-90 kp/mm2, and a resistance of the Ag—Pd alloy bonding wire is within the range of 0.00023-0.00050 ohm, mm2/m.

6. The manufacturing method according to claim 1, wherein the slender grains are adjacent to a central site of the Ag—Pd alloy bonding wire and an amount of the annealing twins to all of the slender grains is above 20%.

7. The manufacturing method according to claim 1, wherein the weight percent of Pd in step b) is 8.73 wt. %.
